(19) United States
(12) Patent Application Publication
(10) Pub. No.: US 2009/0083738 A1
(43) Pub. Date: Mar. 26, 2009

(54) AUTOMATED DATA OBJECT SET ADMINISTRATION

(75) Inventors: Emily Kruglick, Sammamish, WA (US); Bilal Alam, Sammamish, WA (US); Clea H. Allington, Bellevue, WA (US); Kanwaljeet Singla, Bothell, WA (US); Nina Tang, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/943,600

(22) Filed: Nov. 21, 2007

Related U.S. Application Data
(60) Provisional application No. 60/975,125, filed on Sep. 25, 2007.

(51) Int. Cl. G06F 9/46

(52) U.S. Cl. 718/100

(57) ABSTRACT

Modern computer systems may comprise massive sets of data objects of various types, such as data files, application binaries, database objects, proprietary objects managed by applications such as email systems, and system configuration information. Applying complex operations, such as archiving and synchronization operations, to many and varied data objects may be difficult to perform manually or through a script. A more advantageous technique involves applying data object managers to the data object set, where such data object managers are configured to apply various rule comprising a task to be performed on the data object set in furtherance of the operation to various data object types in the data object set. Additionally, the data object set may be modeled as a hierarchical data object set map, to which the rules may be applied through the data object managers in a more uniform manner.

### CROSS REFERENCE TO RELATED APPLICATIONS

This patent application claims the benefit for priority under 35 U.S.C. 119(e) of U.S. Provisional Patent Application No. 60/975,125 (“Automated Data Object Set Administration”), filed on Sep. 25, 2007, which incorporated by reference as if fully rewritten herein.

### BACKGROUND

Modern computer systems often represent a wide assortment of data objects, such as one or more file stores containing a variety of files comprising various kinds of data; binaries comprising compiled code for various applications; an assembly cache containing versioned objects; one or more database systems comprising one or more databases that represent various kinds of data; a system configuration data set (e.g., a system registry) containing data for configuring the hardware and software components of the computer system; and one or more applications containing proprietary data objects (e.g., an email server application that manages access to items in an email data store.) These data objects may be stored and accessed by various subsystems; e.g., a database management system may manage the data comprising one or more databases, while a file system interface may manage the data files of the file stores, and the an email server system may manage the proprietary data objects representing one or more email mailboxes. The complexities of contemporary computing technologies may entail computer systems managing massive numbers and varieties of data objects for achieving a wide range of tasks.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The administration of data object sets for various operations—e.g., analyzing a data object set, archiving a data object set, or synchronizing a data object set—may be made difficult by the wide number of data objects involved in such an operation, and by the large number of data objects involved in the operation. For example, archiving a data object set may involve archiving millions of data files in a file store, terabytes of data stored in various databases, several managed-access subsets of data objects stored in assembly caches or application-specific data stores, and a large data set comprising the system registry. The size and variety of such data objects may be unmanageably by manual coordination, or by low-sophistication task scripts that attempt to perform a generic operation (e.g., “copy to archive device”) on the copious and varied objects of the data object set.

An alternative technique for administrating a data object set involves applying one or more data object managers to the data objects of the data object set with one or more rules that specify tasks to be performed on the data objects in furtherance of the operation. Therefore, a system may be devised involving a set of rules that specify various tasks to be performed on various types of data objects in furtherance of the operation, a set of data object managers configured to apply the rules to particular data objects in the data object set, and an operation coordinator component that is configured to apply the data object managers to the data object set with various rules. Such a system may be capable of performing sophisticated operations on large varieties of data objects in a massive data object set in furtherance of the operation.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flowchart illustrating an exemplary method of performing an operation on a data object set.

FIG. 2 is a flowchart illustrating another exemplary method of performing an operation on a data object set.

FIG. 3 is a component block diagram illustrating an exemplary system of performing an operation on a data object set.

FIG. 4 is an illustration of an exemplary set of accessible data objects represented in various computer systems and presented as a reorganized data object set.

FIG. 5 is an illustration of an exemplary set of accessible data objects represented in various computer systems and presented as a hierarchical data object set map.

FIG. 6 is an illustration of an exemplary rule set for application to a data object set.

FIG. 7 is an illustration of another exemplary rule set for application to a data object set.

FIG. 8 is an illustration of yet another exemplary rule set for application to a data object set.

FIG. 9 is an illustration of yet another exemplary rule set for application to a data object set.

FIG. 10 is a component block diagram illustrating another exemplary system of performing an operation on a data object set.

FIG. 11 is a component block diagram illustrating yet another exemplary system of performing an operation on a data object set.

FIG. 12 is a component block diagram illustrating yet another exemplary system of performing an operation on a data object set.

FIG. 13 is an illustration of an exemplary computer-readable medium comprising processor-executable instructions configured to perform a method or implement a system such as disclosed herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Modern computer systems are tasked with managing many types of data objects. A file server may manage access to one or more file stores, and respective file stores potentially comprising billions of files of various sizes, and may endeavor to provide various forms of access on such files (e.g., rapid access via cache for commonly accessed files; concurrent access for files simultaneously used by many users; and streaming access for large files) on behalf of thousands of users in light of various security and permission parameters. A database server may manage access to a plurality of databases, respective databases potentially comprising thousands of tables hosting billions of records, and may endeavor to perform various tasks on such databases (e.g., complex transactions for multi-step operations, complicated queries requiring extensive processing on multiple tables, and sophisticated logic embedded in stored procedures) on behalf of a wide assortment of data-driven applications, such as database-driven websites. An email server may manage access to several thousand email boxes, and may endeavor to apply various forms of processing (e.g., email group logic, attachment scanning, and sophisticated spam and denial-of-service defensive algorithms) to billions of email messages. Moreover, the computer system may comprise extensive amounts of configuration and management data; for example, the computer system may utilize a system registry containing billions of registry keys comprising the extensive information set that configure the myriad processes comprising the computer system, the applications hosted thereby, and the device controllers incorporated therein.

These complexities of such data object sets—the large number and wide assortment of data objects contained in a data object set, such as the entire data object set comprising a computer system—may hamper administrative functions. For example, a system administrator may wish to create an archive image of the various data objects comprising the computer system, but it may be very difficult to coordinate archiving the data file objects through the file system, the database objects through the database system, the proprietary email data objects through the email system, and the system configuration information through the system registry management system. Similarly, a webserver administrator may wish to synchronize two webservers in a webserver farm, but it may be difficult to construct synchronization processes for the databases deployed on each system and the web content data sets having different sets of virtual mappings (e.g., where one webserver is a staging/development webserver having various mappings to protected file stores within an intranet, and where the other webserver is a public/production webserver having various mappings to publicly accessible file stores.) For data object sets comprising a large number of data objects, and for data object sets comprising a large variety of data objects (e.g., file stores, databases, email server systems, and system registries), the manual manipulation of such data object sets by a system administrator may be prohibitively time-consuming and error-prone. A system administrator may endeavor to write a script to perform some tasks in an automated and generic manner, but such techniques may be unsuitable. For example, a system administrator may endeavor to create an archive of the data object set with a “copy all data objects to an archive device” script, but this script may fail to archive the proprietary data objects comprising an email system that does not provide per-object access, and may fail to invoke an archive procedure stored in a database system specially configured to archive and restore relationally linked data objects. Also, system administrators may be unable to perform more sophisticated operations by hand or by script, such as multivariate synchronization processes that reconcile divergent data object sets based on many factors (data object types and sizes, versioning records, last-modified and last-accessed dates, user and code access security data, etc.)

An alternative technique for performing administrative operations on data object sets involves a more abstract, ad-hoc modeling of various aspects of the operation, and the joint use of the various aspects to achieve a more accurate result. For example, the various data objects in the data object set may be modeled in a more uniform manner, such as nodes of a hierarchical data object set representing the data objects of the data object set. The data objects may then be described according to various aspects that are relevant to the administrative operation to be performed; e.g., groups of data objects may be devised representing various aspects, such as all of the data objects (content files, application binaries, database objects, email mailboxes, and registry configuration information) comprising a particular data-driven application, such as a webserver for a particular website. The administrative operation may also be represented as a more abstract, ad-hoc model that applies sophisticated logic to the data objects; e.g., the operation may specify that all of the data objects comprising the content of a webserver are to be copied to a sandbox area and registered with a debugger in a computer system comprising a staging/development webserver, and copied to an indexed, rapid-access area and registered with an archive device in a computer system comprising a public/production webserver. Also, the abstract model of the operation may be applied to the modeled data object set through one or more data object managers, where each data object manager is designed to interact with particular types of data objects in furtherance of the operation; e.g., an ODBC data object manager may be provided to manipulate the modeled data objects in one or more ODBC-accessible databases in light of the parameters of the operation, while an IMAP server data object manager may be provided to manipulate the modeled data objects in one or more IMAP-compliant email servers in order to conduct the operation.

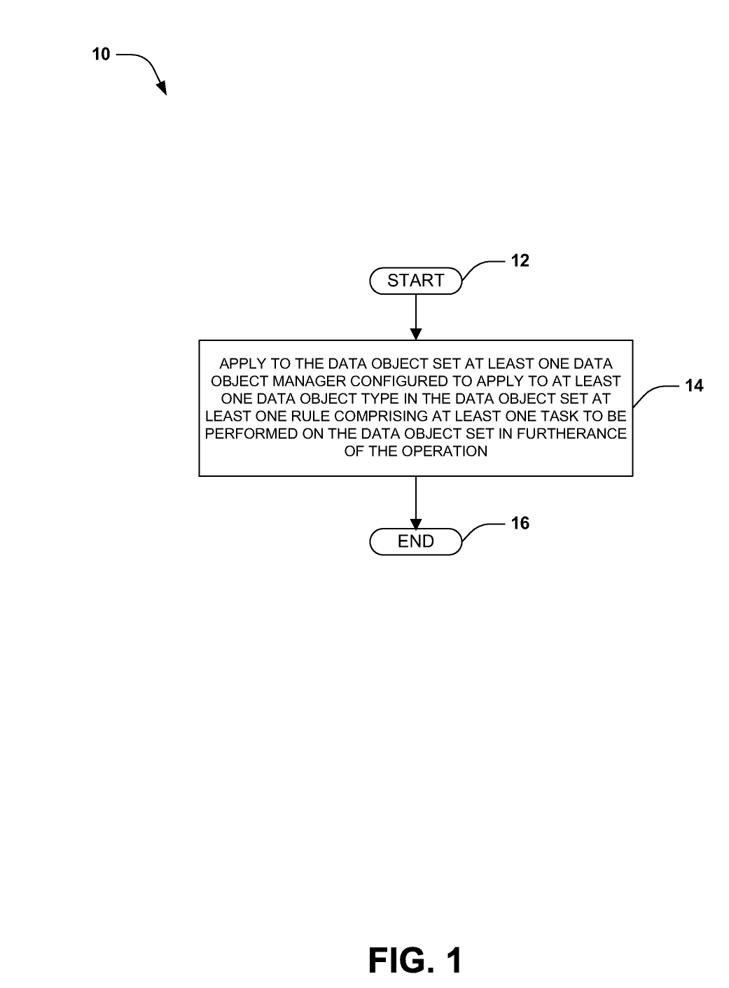

These techniques may be included in a method of performing an operation on a data object set, and an exemplary method that utilizes such techniques is illustrated in FIG. 1. This method 10 begins at 12 and involves applying to the data object set at least one data object manager, where such data object manager is configured apply to at least one data object type in the data object set at least one rule comprising a task to be performed on the data object set in furtherance of the operation 14. The application of such rules to the data object set by one or more data object managers may result in the performance of the tasks specified by the rules to the data objects comprising the data object set, and such application may be performed appropriately for various types of data objects (e.g., data files, database-related data objects, and registry entries) through the data object managers corresponding to the type of each such data object. Having applied the rules representing one or more tasks for furthering the operation to the data object set through the data object managers, the method 10 thereby performs the described operation on the data object set, and therefore the exemplary method 10 ends at 16.

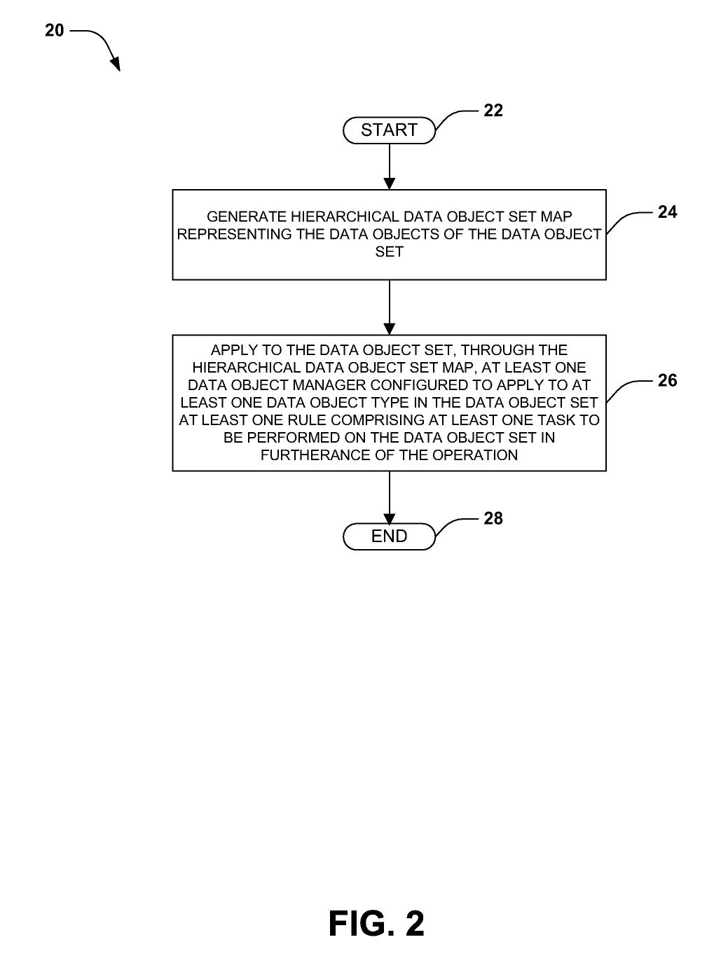

Another exemplary method of performing an operation on a data object set is illustrated in FIG. 2. This method 20 begins at 22 and involves preparing a hierarchical data object set map representing the data objects of the data object set 24. The hierarchical data object set map may be useful for providing a more uniform information set on which the rules comprising the operation may be performed; for example, the hierarchical data object set map may include nodes representing data objects of a database system (e.g., databases, data tables, and records), of an email system (e.g., email boxes and email messages), and of a file system (e.g., file folders and individual data files.) Similar to the application 14 of the exemplary method 10 of FIG. 1, the exemplary method 20 of FIG. 2 involves applying to the data object set at least one data object manager, where such data object manager is configured apply to at least one data object type in the data object set at least one rule comprising a task to be performed on the data object set in furtherance of the operation 26. However, this exemplary method 20 applies such data object manages to the data object set through the hierarchical data object set map. For example, the hierarchical data object set map may identify various data objects, including content files, application binaries, database objects, proprietary data objects representing email mailboxes, and registry configuration information, as relating to a particular data-driven application. This information may be used by the method 20 to apply various rules to all such data objects, e.g., “copy all of the data objects pertaining to the data-driven application to the archive device”—and may therefore permit the specification of rules based on criteria more pertinent to the system administrator and the operation at hand. Having applied the at least one data object manager and at least one rule to the data object set through the hierarchical data object set map 26, the exemplary method 20 thereby performs the described operation on the data object set, and therefore the exemplary method 20 ends at 28.

It may be difficult to utilize the administrative tools that are conventionally available to system administrators in order to apply high-level criteria to broad, varied data object sets through various data object managers. Accordingly, a system may be devised to coordinate the modeling of the data objects in the data object set and the application of an abstractly defined operation on the data objects via one or more data object managers. It may be desirable to devise a system for performing an operation on a data object set, such as by the exemplary methods of FIGS. 1 and 2. A system configured to operate in this manner may comprise at least one rule comprising at least one task to be performed on the data object set in furtherance of the operation, at least one data object manager configured to apply the at least one rule to at least one data object type in the data object set, and an operation coordinator component configured to apply the at least one data object manager with at least one rule to the data object set.

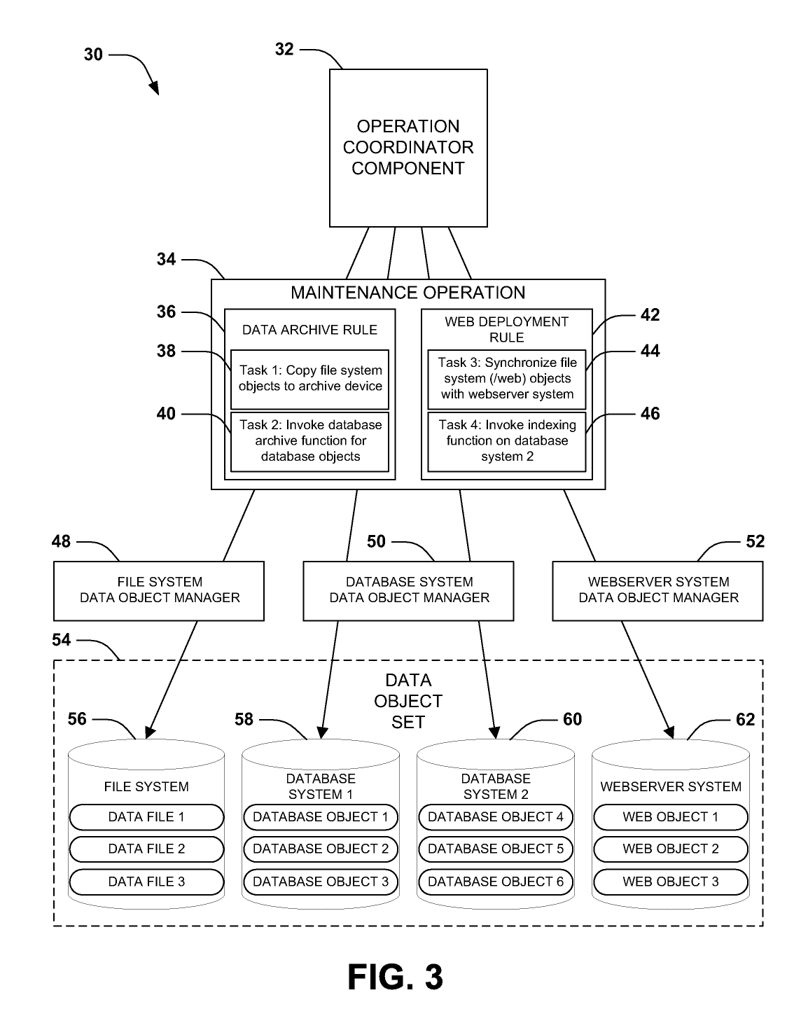

An exemplary system of this nature is illustrated in FIG. 3, where the system 30 operates on a data object set 54 comprising various data objects stored in a file system 56; a first database system 58 and a second database system 60; and a webserver system 62. The exemplary system 30 is configured perform a maintenance operation 34 on the data object set 54 comprising a series of administrative tasks to be executed periodically (e.g., daily) in order to perform routine tasks for maintaining the data object set 54. The maintenance operation 34 of this exemplary system 30 comprises two maintenance rules comprising at various tasks to be performed on the data object set 54 in furtherance of the maintenance operation. The maintenance rules include a data archive rule 36 for performing routine data archive operations, which, in this exemplary system 30, include a first task 38 specifying the copying of the data objects in the file system 56 to an archive device, and a second task 40 specifying the invocation of database archive functions for the data objects in the database systems 58, 60. The maintenance rules also include a web deployment rule 42 for performing tasks related to the maintenance the systems comprising the webserver function, which, in this exemplary system 30, include a third task 44 specifying the synchronization of the data objects in the /web portion of the file system 56 with the webserver system 62, and a fourth task 46 specifying the invocation of the indexing function on the second database system 60, which, e.g., may provide back-end database support for the webserver.

The exemplary system 30 of FIG. 3 also comprises a set of data object managers configured to apply the data archive rule 36 and the web deployment rule 42 to various data object types in the data object set 54. The data object managers include a file system data object manager 48 configured to apply various rules to the data objects in the file system 56; a database system data object manager 50 configured to apply various rules to the data objects in first database 58 and the second database system 60; and a webserver system data object manager 52 configured to apply various rules to the data objects in the webserver system 62.

The exemplary system 30 also comprises an operation coordinator component 32 configured to apply the data object managers 48, 50, 52 with the data archive rule 36 and the web deployment rule 42 to the data object set 54. For example, the operation coordinator component 32 applies the file system data object manager 48 with the first task 38 (involving a file system archive operation) to the data objects in the file system 56. The operation coordinator component 32 also applies the database system data object manager 50 with the second task 40 (involving the invocation of a database archive function) to the data objects of the first database system 58 and the second database system 60, and also with the fourth task 46 (involving the invocation of a database indexing function 60) to the data objects of the second database system 60. In this manner, the operation coordinator component operably couples the rules of the data object managers 48, 50, 52, the rules 36, 42 comprising the maintenance operation 34, and the systems 56, 58, 60, 62 that together contain the data object set 54 in furtherance of the maintenance operation 34.

The exemplary system 30 of FIG. 3 may be extended with additional components that provide advantages and/or mitigate disadvantages with respect to other systems and conventional techniques. For example, the exemplary system 30 might also include a hierarchical data object set map generating component (not shown), which may be operably coupled with the data object set and configured to generate a hierarchical data object set map. Similar to the exemplary method 20 of FIG. 2, a system configured in this manner might apply the data object managers with the rules to the data object set through the hierarchical data object set map, which may yield a more accurate or robust performance of the operation.

It will be appreciated that those of ordinary skill in the art may apply these techniques, including those illustrated in the exemplary methods 10, 20 of FIGS. 1 and 2 and the exemplary system 30 of FIG. 3, in many embodiments. Many such embodiments may present variations in the nature and configuration of the data object set, the data object managers, and the rules describing the operation, and such variations may present advantages and/or mitigate disadvantages with respect to other embodiments and more conventional techniques. Additionally, the operable coupling of the data object set, the data object managers, and the rules (e.g., as achieved by an operation coordinator component, such as the operation coordinator component 32 in the exemplary system 30 of FIG. 3) may be embodied with various aspects that present advantages and/or mitigate disadvantages with respect to other variations and more conventional techniques.

The techniques presented herein may be applied to many types of data object sets. As one example, the data object set may comprise the data objects available to and managed by a computer system, e.g., data files, binaries, device controllers, database objects, and system configuration information. As another example, the data object set may comprise the data objects in a subset of objects accessible to a computer system; e.g., these techniques may be applied to manage various forms of data objects associated with a particular application, such as a webserver application, which may comprise only a subsection of the data objects on the computer system (the binaries comprising the code for the webserver processes, the webserver configuration data objects, some content data files, and a database.) As yet another example, the data object set may comprise data objects stored on a plurality of computer systems; e.g., FIG. 3 illustrates an exemplary system 30 wherein the data object set 54 comprises the data objects collectively managed by the file system 56, the first database system 58, the second database system 60, and the webserver system 62. Many variations of the architecture and nature of the data object set may be administrated according to the techniques described herein.

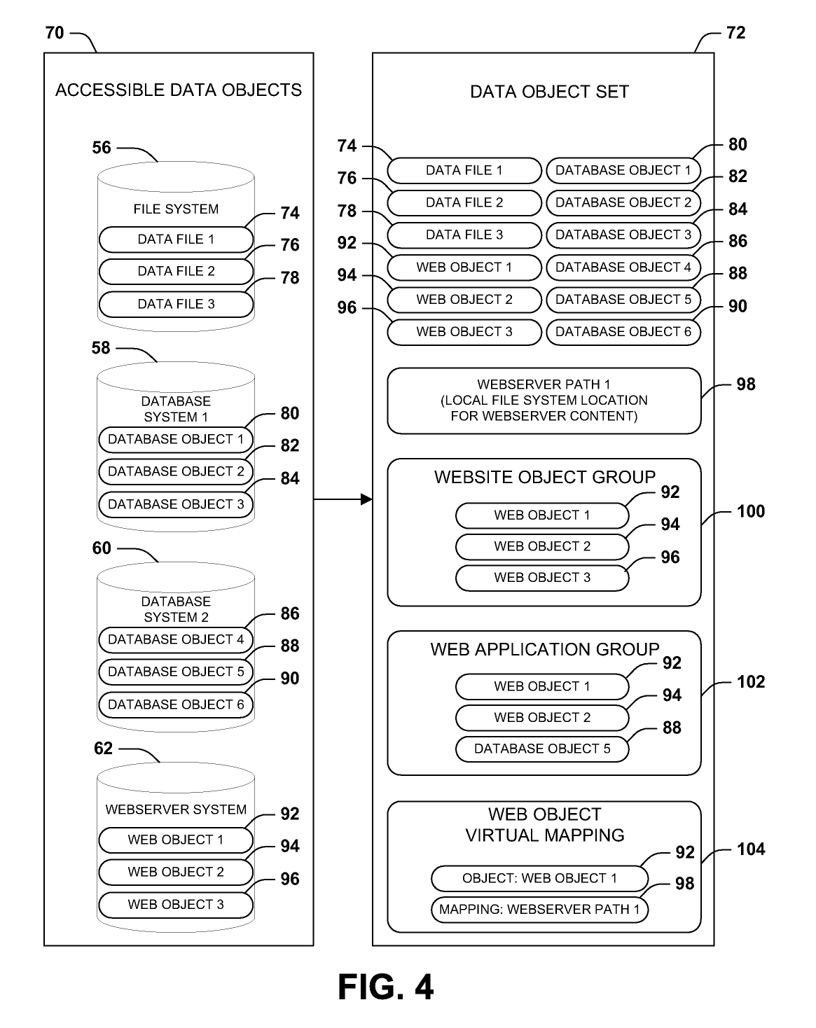

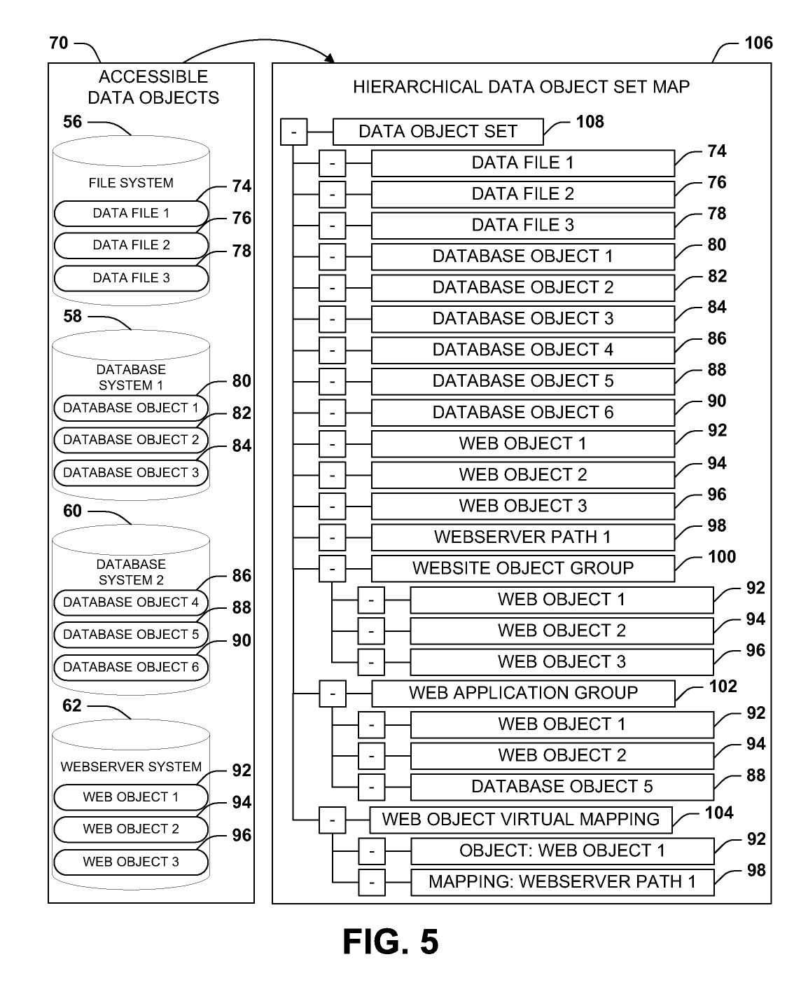

These techniques may also be applied to many types of data objects. The following variations may be better appreciated with reference to FIGS. 4 and 5. The examples illustrated in these figures involve data files managed by a file system 56, database objects managed by a first database system 58 and a second database system 60, and some web objects managed by a webserver system 62. However, the accessible data objects 70 are conceptualized as a somewhat differently organized data object set 72. The data object set 72 therefore organizes the accessible data objects 70 according to various semantic concepts, and the rules applied to such a data object set 72 may specify these semantics, and may thereby indicate the rules and tasks at a higher level of abstraction that enables a more sophisticated performance of the operation.

The data objects to which the techniques described herein may be applied include the data files stored in one or more file systems; the binaries comprising the operating system and the applications available therein; versioned objects stored in an assembly cache; proprietary data objects managed by various applications, such as email management systems; device controllers for accessible peripheral hardware and software devices; and system configuration information, such as configuration files or the keys and values comprising the system registry. It will be appreciated that such data objects are of various data object types: a data file; a database table or a record in a database table; an email account or an email message; a configuration file or a system registry entry representing a unit of configuration information. The various data object types may be utilized as a factor in the rules of an operation (e.g., “for the data objects having a data object type of a database record in a particular database system, invoke the database archive function.”) For example, the accessible data objects 70 of FIG. 4 include a first data object 74, a second data object 76, and a third data object 78 in a file system 56. These data objects may be referenced in the data object set 72 and in rules applied thereto, either individually (e.g., “archive the first data file 74.”) Alternatively or additionally, these data objects 74, 76, 78 may be referenced in the data object set 72 and in rules applied thereto collectively based on the data object type “data file” (e.g., “archive all of the data files 74, 76, 78”), and/or based on the mechanism for accessing such objects (e.g., “archive all of the data objects managed by the file system 56.”)

The data objects may also include information detected or derived with respect to the computer systems and the contents thereof. For example, data objects may be constructed and included in processing these techniques (e.g., may be specified in one or more rules) representing various file system locations that have semantic value in the computer system, such as the file system location representing the root of a content file system exposed by a webserver. While such semantic information may not directly correspond to a data object, such as a data file or a registry entry, the semantic information may nevertheless be represented as a data object comprising the information derived from the computer system and contents thereof. This derived data object may then be referenced by one or more rules in carrying out the specified operation (e.g., “copy to an archive device all of the files located within the content file system of the webserver.”) A derived data object may be represented in these techniques as a conventional data object type, e.g., as a “data file” data object type (despite no such data file exists in the file system.) Alternatively or additionally, a derived data object may be processed in these techniques as a novel and custom data object type, e.g., as a data object type identified as a “virtual directory identifier.” In FIG. 4, the data object set 72 includes a derived data object representing a first webserver path 98, which specifies the location in the local file system 56 that the webserver system 62 exposes to the public (e.g., “C:\inetpub\wwwroot\”.) The information representing the first webserver path 98 may be derived from the accessible data objects 70, e.g., based on the configuration information for the webserver system 62. Moreover, the first webserver path 98 is represented as a derived data object that may be specified in rules applied thereto (e.g., “record the first webserver path 98 on the archive device.”)

Various data objects may also be aggregated as a data object group, which may be aggregately referenced by a rule and may be acted upon in a similar manner in accordance with such rules. For example, a data-driven application may comprise a large number and variety of data objects, such as a collection of data files, binaries, database objects, and system configuration information; and data object group may be formed representing all such data objects that pertain to the data-driven application. The groups may comprise a homogenous set of data objects (e.g., data objects of the same data object type, such as similar types of data files, or data objects managed by the same data system) or a heterogeneous set of data objects (e.g., different types of data objects, such as a set of database records and a set of data files that are conceptually related to the database records.) Such groups may facilitate the development of rules with respect to all of the data objects comprising the data object group. A rule may therefore reference the data objects based on the conceptual groups, which may be syntactically more accurate and robust than specifying the individual data object and/or data object types. In FIG. 4, the exemplary data object set 72 includes a data object representing a website object group 100, which includes the data objects that are conceptually related as the data objects to which the webserver system 62 provides public access. The exemplary data object set 72 of FIG. 4 also includes a heterogenous data object group, in which a web application group 102, comprising both a first web object 92 and a second web object 94, and also a database object 88, is conceptualized as a single data object in the data object set 72. A rule may therefore be formulated specifying the heterogeneous types of data objects comprising the conceptual group (e.g., “archive the various data objects 92, 94, 88 comprising the web application.”)

Another type of data object may be included in a data object set that characterizes the roles of the data objects in a particular conceptual relationship. For example, two or more data objects are not just conceptually grouped, but interrelate as different roles in a multi-object concept. For example, a linking data object may relate a data file comprising a document with a data object comprising a resource, such as an image, that is included in the document data object. Such linking relationships may be represented as a linking data object, which specifies various data objects in addition to the role that the data objects occupy in the linking relationship. The linking data objects may then be specified in rules applied to the data object set (e.g., “archive the documents in the file system, and also archive the data files comprising resources that are included in the documents in the file system.”) Such linking data objects may further facilitate the development of rules that apply to the data object set in more accurate and robust formulations. For example, in FIG. 4, the data object set 72 includes a linking data object representing a web object virtual mapping 104, which conceptually links a first web object 92 that is hosted by the webserver system 62 with a first webserver path 98 by which the first web object 92 may be locally accessible. The web object virtual mapping 104 may then be specified in a rule applied to the data object set at a comparatively high level of abstraction (e.g., “for each data object comprising the web application group 102 [such as the first web object 92], record in the webserver log the local file system path for the data object specified in a web object virtual mapping [such as the first webserver path 98 specified for the first web object 92 in the web object virtual mapping 104].”)

It will be appreciated through examination of FIG. 4 that the accessible data objects 70 may be presented to the techniques described herein as a somewhat differently organized data object set 72 (e.g., the first web object 92 is exposed as an individual data object, as a component of the website object group 100, as a data object comprising a web application group 102, and as the object of a web object virtual mapping 104.) In some embodiments of these techniques, these conceptual reorganizations may be computed on a just-in-time basis, e.g., as needed in order to interpret and apply various rules. For example, the rules may be applied to the various accessible data objects unless a rule specifies a more abstract or conceptual type of data object, such as “the data objects comprising the web application,” in which case the accessible data objects may then queried in order to determine which data objects comprise the web application. In other embodiments, the conceptually reorganized data object set may be derived by analyzing the accessible data objects and providing the reorganization before evaluating any rules. In one such embodiment, the accessible data objects may be organized into a hierarchical data object set map, which endeavors to represent all of the accessible data objects, as well as the data object groups, and the linking data objects) in a hierarchical map.

FIG. 5 illustrates one possible formulation of a hierarchical data object set map 106. This hierarchical data object set map 106 presents a reorganization of a set of accessible data objects 70 (including derived data objects 98, data object groups 100, 102, and linking data objects 104 related thereto) as a unified hierarchical data object set to which the rules may be applied. This technique may present the advantage of organizing the various data objects in a more regular manner, such that the system devised to apply the rules to the data object set may more easily implement the processing logic against the regularly organized hierarchical data object set map 106 than against a more haphazard arrangement of data objects of various data object types stored in disparate computer systems 56, 58, 60, 62, and against the conceptual objects related thereto (e.g., derived data object such as the first webserver path 98, data object groups such as the website object group 100 and the web application group 102, and linking data objects such as the web object virtual mapping 104.) Accordingly, a system may be devised according to this technique (e.g., by implementing the exemplary method of FIG. 2) to generate a hierarchical data object set map representing the data objects of the data object set before applying the data object managers with the rules to the data object set.

Many techniques may be used to formulate a hierarchical data object set map from a set of accessible data objects. As one example, the hierarchical data object set map may be formulated as a relational database that maps data objects, data object groups, and linking data objects to various accessible data objects, and that includes additional data objects representing derived data objects. This example may be advantageously compatible with various relational database query and manipulation technologies, such as SQL-formulated queries and database record indices that provide rapid access to selected records. As another example, the hierarchical data object set map may be formulated as a structured document, such as an XML file based on a particular XML schema, which may be advantageously compatible with various XML query and manipulation techniques, such as XSL transformations and XPath queries. Those of ordinary skill in the art may be able to devise many such techniques for formulating a hierarchical data object set map in accordance with the techniques described herein.

The techniques disclosed herein also involve one or more rules that are applied to the data object set in furtherance of the operation. Each rule may specify one or more tasks that may be performed to apply the rule to the data set. For example, the exemplary system 30 of FIG. 3 is configured to perform a maintenance operation 34 having a data archive rule 36 devised to store images of various data objects on an archive device. The data archive rule 36 comprises a first task 38 for copying the data objects in the file system 56 to an archive device and a second task 40 for invoking a database archive function on the data objects comprising the first database system 58 and the second database system 60. By specifying the tasks comprising various rules in this manner, these techniques may permit the elucidation of an operation according to various abstract principles that may be robustly and accurately applied to a massive set of various data objects.

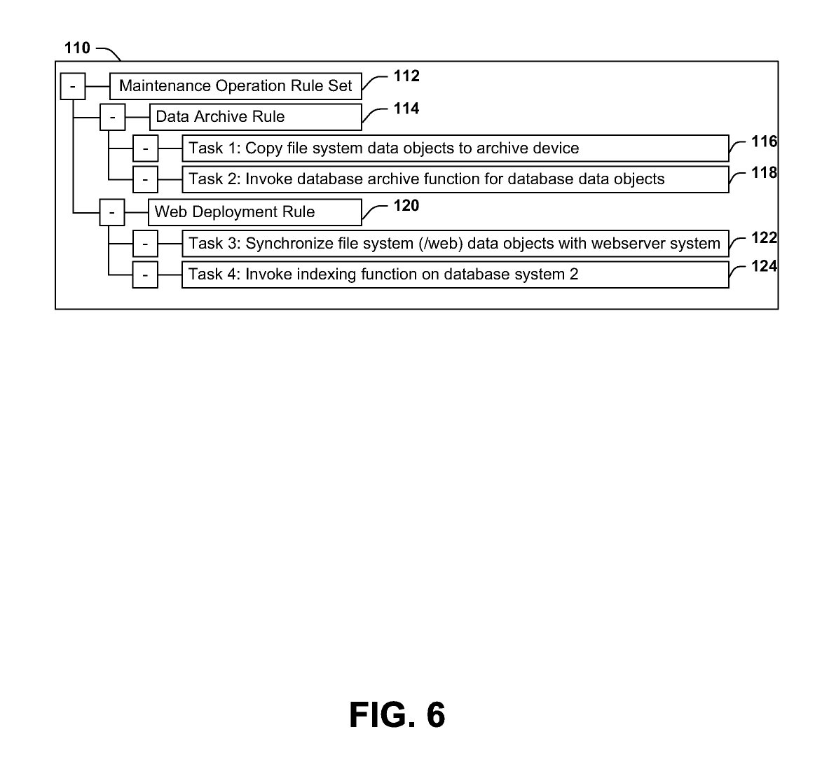

The rules that such techniques apply to data object sets in furtherance of an operation may be organized in many variations. One example is illustrated in FIG. 6, in which the exemplary operation set 110 specifies a maintenance operation rule set 112 for performing a maintenance operation on a data object set, such as the set of accessible data objects 70 managed by the file system 56, first database system 58, second database system 60, and webserver system 62 in FIGS. 4 and 5. The maintenance operation rule set 112 in the example of FIG. 6 comprises two rules: a data archive rule 114 and a web deployment rule 120. The data archive rule 114 includes two tasks: a first task 116 specifying the copying of the data objects in the file system to an archive device, and a second task 118 specifying the invocation of a database archive function on the data objects in the database systems. The web deployment rule 120 includes two tasks: a third task 122 specifying the synchronization of the data objects in the /web folder of the file system with the webserver system, and a fourth task 124 specifying the invocation of a database indexing function on the data objects in the second database system.

The organization of various tasks within various rules such as in the exemplary operation set 110 of FIG. 6 may permit a fairly straightforward description of the operation to be performed on the data object set. However, the tasks performed within the rules are wholly specified therein, and may be embodied as custom-built sets of operations for performing each such task (e.g., the first task 116 may be implemented as a set of computer-executable instructions configured to perform a copy operation of the file system data objects to the archive device.) The ad-hoc formulation of sets of computer-executable instructions for each task within a rule does not easily facilitate the maintenance or reuse of sets of instructions. For example, adjusting the mechanics of one type of task—e.g., if new information is to be added to the “copy” tasks in order to apply the rules to a new type of file system—may involve altering the set of instructions comprising each “copy” task.

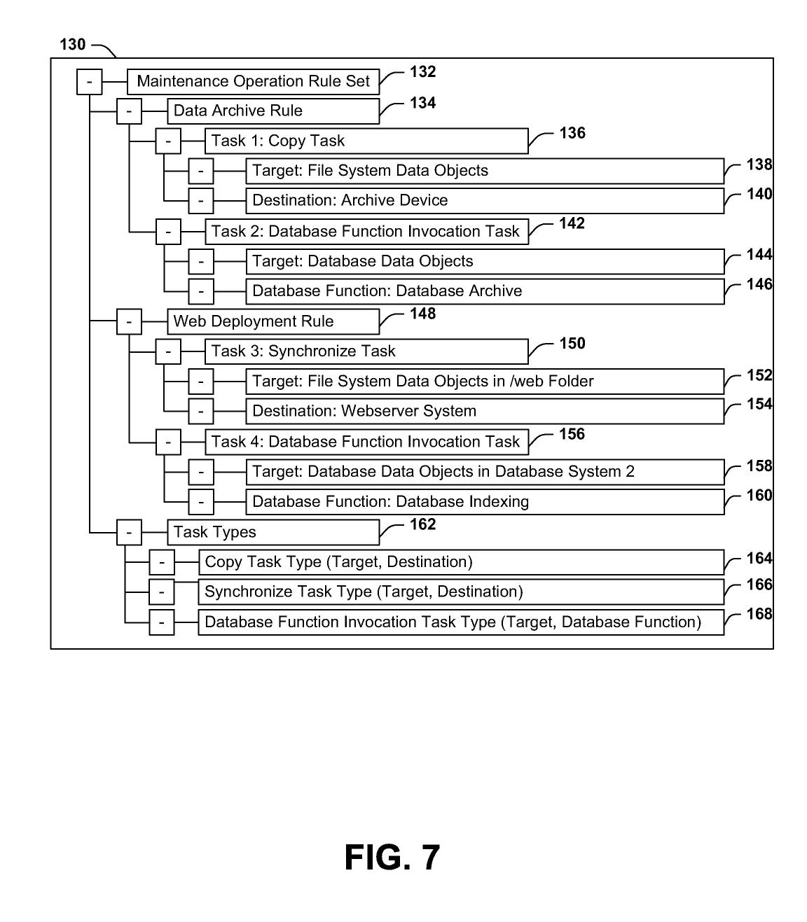

By contrast, another exemplary rule set is illustrated in FIG. 7 that includes a set of task types 162 that the various rules utilize in specifying the performance of the operation. The exemplary operation set 130 of FIG. 7 again specifies the maintenance operation rule set 132 for application to a data object set such as illustrated in FIGS. 4 and 5, and the maintenance operation rule set 132 again comprises a data archive rule 134 comprising a file system archive task and a database archive task, and a web deployment rule 148 comprising a synchronization task and a database indexing task. However, in this exemplary operation set 130, the tasks 136, 142, 148, 156 are not embodied as per-task sets of computer-executable instructions as in FIG. 6, but as applications of the task types 162 included in the maintenance operation rule set 132. For example, the data archive rule 134 comprises a copy task 136 based on the “copy” task type 164, which is generically configured to copy specified data objects to a specified destination, and a database function invocation task 142 based on the “database function invocation” task type 168, which is generically configured to invoke a database function with respect to specified data objects. Similarly, the tasks comprising the web deployment rule 148 are represented in the maintenance operation rule set 132 in FIG. 7 are now specified as a synchronize task 150 based on the “synchronize” task type 166, which is generically configured to synchronize two sets of data objects (but only for data objects in the /web portion of the target file system), and an indexing function task 156 based again on the “database function invocation” task type 168, but which, for this task, invokes a database indexing function for various data objects (but only for data objects stored in the second database system.) By specifying various tasks based on the task types 162 available to the maintenance operation rule set 132, the exemplary operation set 130 may be more easily applied to various computer systems. For example, the rules may be applied to a novel file system by updating the operating instructions comprising the task types 162 that generically interact with the file system, such as the “copy” task type 164.

Rules devised in this manner may be applied to support many types of operations on a data object set. For example, administration of a computer system may involve the performance of data object set analysis operations (e.g., a data dump); data archive and restore operations involving various types of archive devices; server deployment operations (e.g., deploying a webserver having a content data object set, various web applications, and a set of webserver configuration information); unidirectional or bidirectional synchronization operations (e.g., mirroring one data object set to another, and merging divergent data object sets based on various criteria); maintenance operations (e.g., a set of tasks performed periodically for maintaining the data object set); and migration operations (e.g., for reconfiguring the data object set in order to support the migration to a new application version, such as from one version of a webserver software to a newer version of the webserver software.) Many such operations may be provided for a data object set, and may involve many rules comprising many tasks in furtherance of the operations.

Just as the task types may be generically represented and reused, so too may rules be generically represented and reused, such that a particular rule may be included in various operations. Instead of providing a series of ad-hoc rules for carrying out each operation, the operation rule set may define a series of generic rule types, and the operations may be specified by invoking the rule types in specific contexts. For example, if several operations depend on performing an archive of the data object set, then a rule type may be created to perform a data object archive of the entire data object set, and each operation may invoke the data object archive rule type to perform the data object archive. This organization may facilitate administration of the rule types; for example, adjustments to the rules for archiving the data object set (e.g., the tasks and task types employed thereby) may be applied to the data object set archive rule type, which will then become effective for every operation that invokes the data object set archive rule.

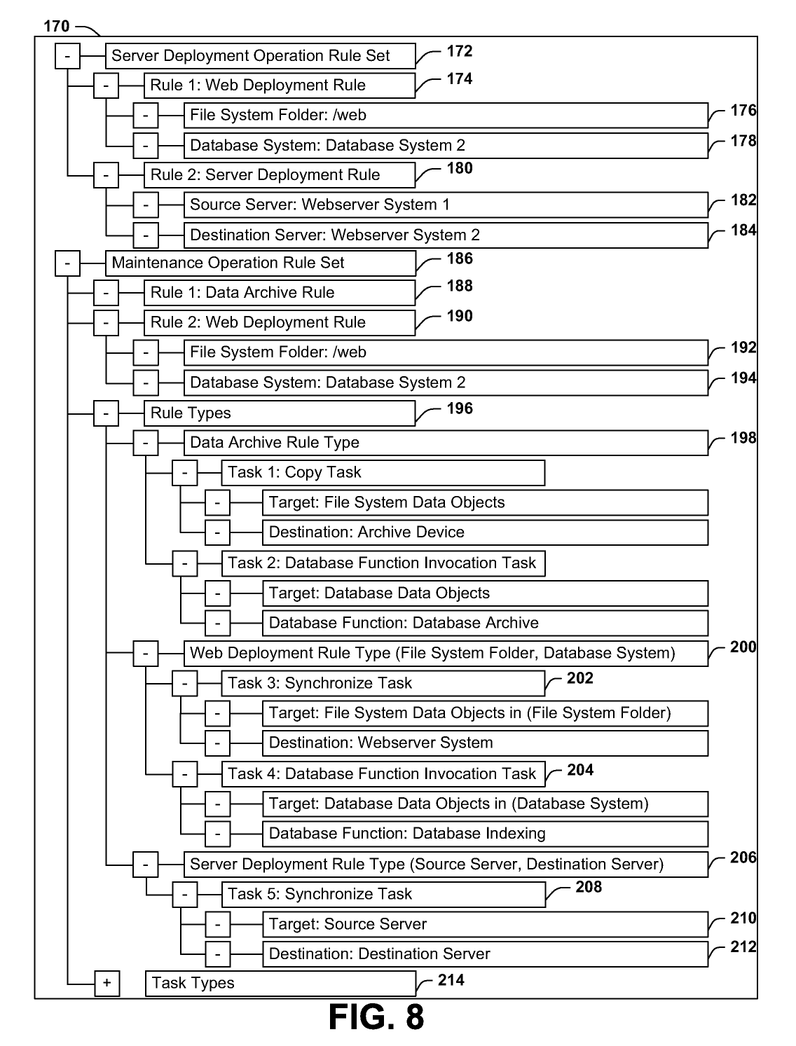

FIG. 8 illustrates an example of this formulation of operations according to generic rule types. As in the previous examples, the exemplary operation set 170 specifies a maintenance operation rule set 186 for application to a data object set such as illustrated in FIGS. 4 and 5; and as in the example of FIG. 7, the rules are specified in terms of generic task types 214. However, a server deployment operation rule set 172 is also included, which is provided for the deployment of a new webserver based on the contents of a current webserver, such as by synchronizing a source webserver system to a destination webserver system. Like the maintenance operation rule set 186, the server deployment operation rule set 172 also invokes the web deployment rule 174 in order to update the contents of the (source) webserver system, and then invokes a server deployment rule that synchronizes the (source) webserver system with a new (destination) webserver system. Moreover, in the exemplary operation set 170 of FIG. 8, the rules comprising the operation rule sets 172, 186 invoke generic rule types 196, which are in turn configured to invoke various sets of tasks based on generic task types 214. For example, the web deployment rule type 200 is now represented as a generic rule for updating the content of a webserver, comprising the tasks of synchronizing the webserver with a specified portion of a file store (via the Synchronize Task rule type 202) and invoking the database indexing function 204 to update the indices in the database system for the database-stored data objects utilized by the webserver. The web deployment rule type 200 is then utilized in both the server deployment operation rule set 172 and the maintenance operation rule set 186. Additionally, the server deployment operation rule set 172 also utilizes a server deployment rule 180 for synchronizing a source webserver 182 with a destination webserver 184, and the server deployment rule 180 is based on a server deployment rule type 206 that invokes a synchronize task 208 on the specified source server 210 and destination sever 212 (based in turn on a synchronize task type defined in the generic task types 214.) By specifying the operation rule sets 172, 186 based on generic rule types 196, the exemplary operation set 170 of FIG. 8 thereby facilitates the maintenance and reuse of rule sets incorporated in such operation rule sets.

The exemplary organizations of rules presented in FIGS. 6, 7, and 8 may also be varied in other ways. As one example, the rules may specify objects in the data object set according to various techniques, as will be illustrated with reference to the exemplary system illustrated in FIG. 4. As one example, a rule may specify individual data objects in the data object set (e.g., “write specific information to the third data file 78 in the file system 56.”) As another example, a rule may specify a set of data objects based on a common aspect, such as the data object type (e.g., “archive all data objects of type ‘file’,” which includes the first data file 74, the second data file 76, and the third data file 78), the name (e.g., “archive all data objects named ‘Project 7’”), or the computer system responsible for managing the data objects (e.g., “archive all data objects managed by the webserver system 62,” which includes the first web object 92, the second web object 94, and the third web object 96.) As yet another example, a rule may specify a data object group representing a group of data objects (e.g., “archive the web application group 102,” which includes the first web object 92, the second web object 94, and the fifth database object 88.) As yet another example, a rule may specify one or more data objects referenced in a linking data object (e.g., “write to the system log all mappings specified in web object virtual mapping data objects,” which includes the first webserver path 98 identified in the web object virtual mapping 104.) As yet another example, a rule set may incorporate a sophisticated information query system, such as XPath, SQL, or regular expression syntax, and rules may specify one or more data objects according to a structured query (e.g., “archive the data objects returned by the following query on the second database system: select * from [Table] where [Project_Name]=‘Project 7’ . . . ”) Those having ordinary skill in the art may devise many techniques for identifying data objects to which various rules are to be applied in accordance with the techniques described herein.

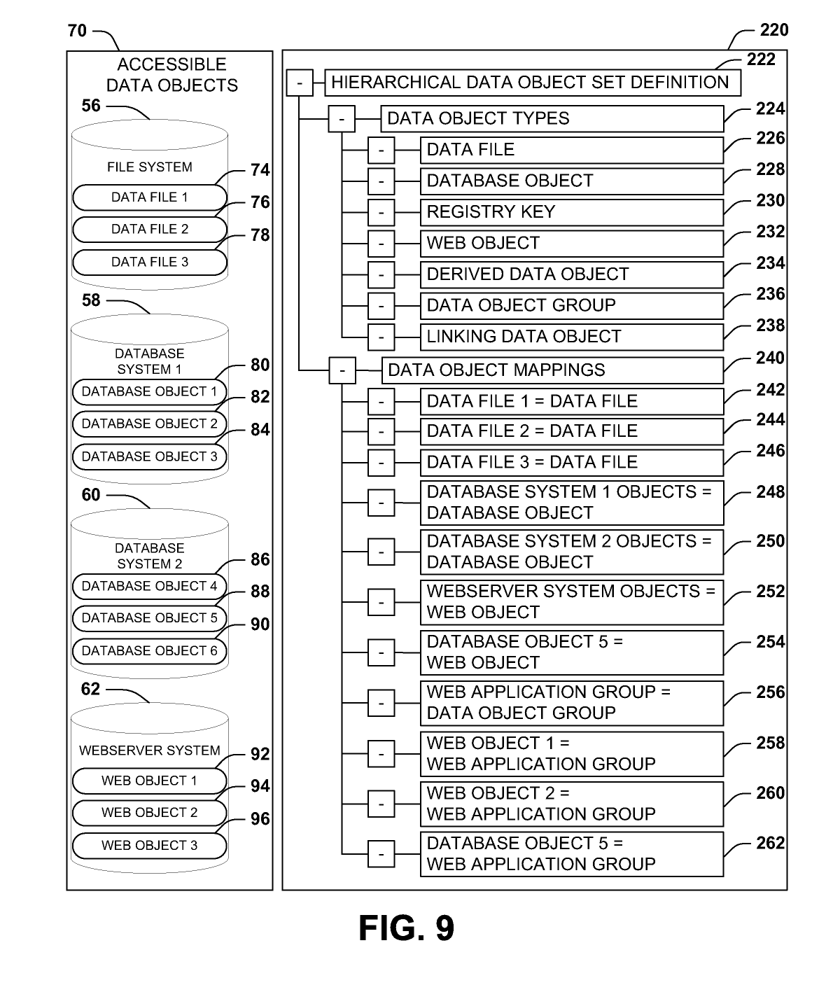

FIG. 9 illustrates a more substantial variation in the manner of identifying data objects for application of rules in an operation and rule set involves the formulation of a hierarchical data object set map, such as generated at 24 in the exemplary method 20 of FIG. 2 and illustrated as 106 in FIG. 5. In one embodiment, the operation and rule set may provide criteria for preparing a hierarchical data object set map to which the rules are to be applied. For example, the operation and rule set may define the data object types represented in the hierarchical data object set map, and may specify the mapping of the data object set to the hierarchical data object set map in preparation for applying thereto the rules specified in the rule set. The example illustrated in FIG. 9 includes an exemplary operation and rule set 220 for application to a data object set, such as the exemplary data object set 70, through a hierarchical data object set map, which is to be generated in a particular manner. Accordingly, the exemplary operation and rule set 220 specifies a hierarchical data object set definition 222, which describes the manner of preparing the hierarchical data object set map. The hierarchical data object set definition 222 specifies a set of data object types 224 that may be represented in the hierarchical data object set map, such as a data file 226, a database object 228, a registry key 230, and a web object 232. The hierarchical data object set definition 222 also specifies conceptual data object types that may be represented in the hierarchical data object set map, such as a derived data object 234 (e.g., the first webserver path 98 illustrated in FIG. 4), a data object group 236 (e.g., the web application group 102 illustrated in FIG. 4), and a linking data object 238 (e.g., the web object virtual mapping 104 illustrated in FIG. 4.)

As further illustrated in FIG. 9, the hierarchical data object set definition 222 may also specify one or more data object mappings 240, which represent data objects in the hierarchical data object set map and relate the data objects to the accessible data objects 70. For example, some accessible data objects may be directly identified in the hierarchical data object set map. For example, in a hierarchical data object set map generated by applying the hierarchical data object set definition 222 to the accessible data objects 70, the first data file 74, second data file 76, and third data file 78 are represented as data objects 242, 244, 246 of type “data file,” respectively. The data object mappings 240 may also indicate that a data object is to be represented in the hierarchical data object set map as a different data object type; e.g., the fifth database object 88 is to be represented in the hierarchical data object set map as both a database object 250, and also as a web object 254 (due to its participation in a particular data-driven web application, as illustrated in previous examples.) The hierarchical data object set definition 222 may also indicate that a set of data objects is represented in the hierarchical data object set map as a particular data object type; e.g., according to two such mappings 248, 250, all data objects comprising data objects in (respectively) the first database system 58 and the second database system 60 are to be represented in the hierarchical data object set map as data objects of type “database object.” The data object mappings 240 in the hierarchical data object set definition 222 may also specify the creation of conceptual data objects. For example, the data object mappings 240 specify the creation of a data object group for the web application group 256, and also specify that the first web object 92, the second web object 94, and the fifth database object 88 are to be mapped 258, 260, 262 within the web application group. Accordingly, a computer system configured to apply an operation and rule set to a data object set may first be directed by the same rule set to formulate a hierarchical data object set map, and to apply the rules to the data object set through the hierarchical data object set map as described herein.

Another aspect of the specified rule sets that may vary among implementations of these techniques relates to the order in which the rules are applied. In one embodiment, the rules comprising an operation may be applied in serial order until all rules are completed, whereas in another embodiment, the rules may be invoked in parallel and applied to completion. In a third embodiment, the rules may be applied in a hierarchical order. As one example of this embodiment, the data objects that are handled by the first rule may be considered resolved, and may be withheld from processing according to subsequently specified rules. This arrangement may be useful, e.g., in an archive operation, where various rules are specified to perform archiving operations on certain types of data objects; in this arrangement, the data objects that are successfully archived by a rule are excluded from the application of subsequent rules. As another example of this embodiment, the rules may expressly apply only to certain kinds of data objects; e.g., the data archive rule 134 in FIG. 7 may be associated only with data objects in databases and file systems, and may not be associated with data objects comprising system configuration information. Rules identified in this manner may therefore be selectively applied to pertinent data objects, thereby reducing the inefficiency in attempting to apply the rule to data objects to which the rule does not pertain. As still another example, a rule may indicate that certain data objects are exempted from processing by another rule, such as by omitting the application of the other rule to particular data objects. Many variations in the order of application of the rules while performing an operation may be devised by those of ordinary skill in the art while relying on the techniques described herein.

Rule sets such as described herein and illustrated in FIGS. 6, 7, and 8 may also be formatted in many ways. In one embodiment, the operations, rules, and tasks may be specified in a partially or wholly compiled form, such as one or more compiled binaries comprising computer-executable instructions (e.g., machine code or intermediate language code) for carrying out the operations, rules, and tasks. This embodiment may present the advantage of expedient execution by the computer system, but may be difficult for system administrators to interpret or adjust without recompiling the binary from one or more source code modules. In an alternative embodiment, the operations, rules, and tasks may be formatted as human-readable text, such as an XML data file, that are parsed during the application of the rules to a data object set (e.g., by an operation coordinator component, such as the operation coordinator component 32 in the exemplary system 30 of FIG. 3.) The formatting of the rules as human-readable text may present the advantages of easy cognition of the logical operation of the operations, rules, and tasks, and of facilitated maintenance thereof. For example, a system administrator may understand the methods performed in an operation by reading through the XML-based rule set, and may be updated by adding new rules or adjusting existing rules via a standard text editor. The tasks incorporated thereby may be performed by reference to externally compiled code (e.g., a “synchronize” task may reference a synchronize function provided by an operating system or application, or a code module containing the compiled instructions for performing the synchronization, such as the name of a dynamic link library.) Alternatively or additionally, the human-readable text may comprise a human-readable script that may be interpreted by the computer system in performance of the task, e.g., a batch script that the operating system may follow to perform the specified task. Many variations in the formatting of the instructions specifying various operations, rules, and tasks for human and computer consumption may be devised by those of ordinary skill in the art in accordance with the techniques described herein.

The operations and rules may be applied to a data object set (possibly through a hierarchical data object set map), and this application may be performed by an operation coordinator component, such as the operation coordinator component 32 in the exemplary system 30 of FIG. 3. However, it may be difficult for such a component to apply the various rules to data objects through various interfaces provided by the systems that manage these data objects. For example, a rule specifying the copying of various data objects may involve copying some data objects from a file system 56, a first database system 58 and a second database system 60, and a webserver system 62. It may be advantageous to formulate one or more data object managers, where each data object manager is configured to apply rules to particular data object types. For example, a file system data object manager 48 may be configured to apply the rules to data files, such as through an interface provided by the file system 56 that manages access to data files, while a database system data object manager 50 may be configured to apply the rules to database objects, such as through interfaces provided by various database systems 58, 60. The operation coordinator component 32 may therefore rely on the data object managers 48, 50, 52 to interpret the rules appropriately for respective data object types, and may therefore process the operations and rules without regard to the access mechanisms and computer systems through which the data objects are exposed. The data manager objects 48, 50, 52 may also be privy to relationships between various data objects in the specialized context that such data object types occupy. For example, the file system data object manager 48 may have access to information that two data files are associated and are to be operated as a unit, and may therefore interact with the data objects of such data object types and apply rules thereto in light of such contextual relationship information.

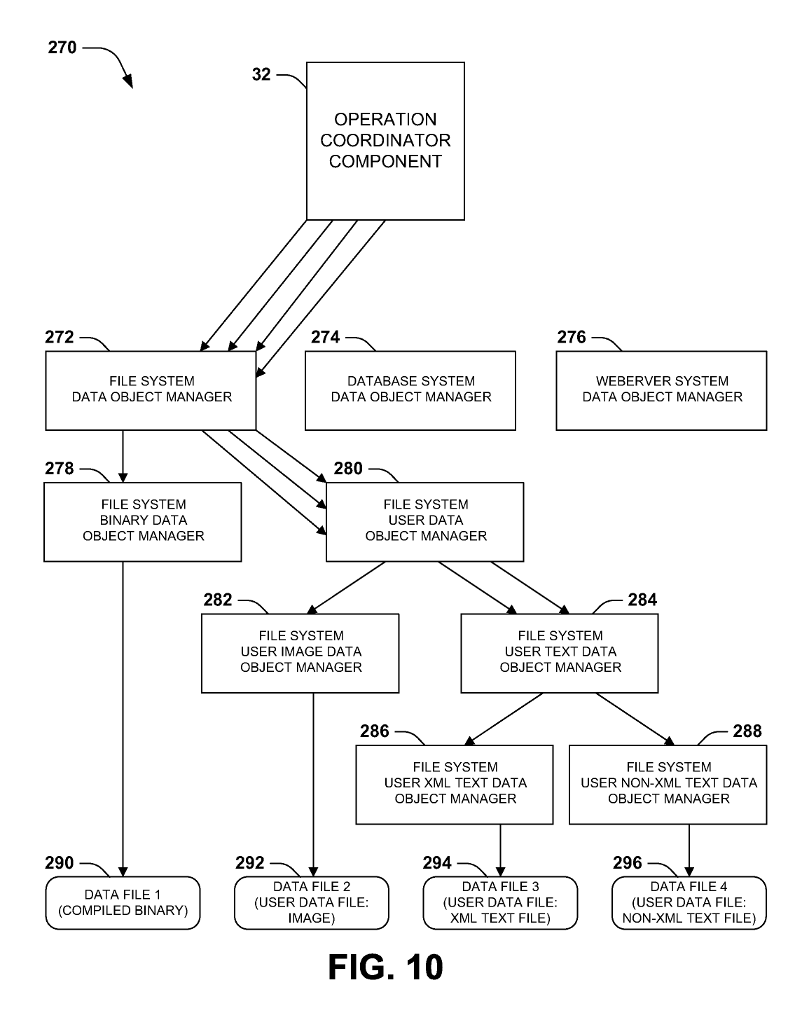

The data object managers may be configured in many various aspects to apply the rules and tasks to particular data object types in the data object set, and such variations may present advantages and/or mitigate disadvantages with respect to other configurations and/or conventional techniques. In one embodiment, the data object types may comprise multiple levels of specialization, and the data object managers may be organized in a hierarchy for handling various degrees of specializing among data object types. FIG. 10 illustrates an exemplary hierarchical arrangement of data object managers configured to manage data object types through several levels of data object type specialization. In the exemplary data object manager set 270 in FIG. 10, an operation coordinator component 32 endeavors to apply a set of data object managers 272, 274, 276 with a rule of an operation (e.g., a rule including a “print” task that directs the rendering of various data objects on a printing device) to a plurality of data objects 290, 292, 294, 296. The operation coordinator component 32 determines that these four data objects are of the data file object type, and therefore applies the file system data object manager 272 with the “print” task to the data objects 290, 292, 294, 296. The file system data object manager 272 is operably coupled to two more specialized data object managers: a file system binary data object manager 278 that is configured to apply rules to binary data objects, and a file system user data object manager 280 that is configured to apply rules to user data objects. The first data file 290 is determined to be a binary data file, and so the file system data object manager 272 provides the first data file 290 to the file system binary data object manager 278, which applies the “print” task to the binary file (e.g., by displaying some metadata derived from the file manifest, or by skipping the print operation altogether for the unprintable binary data object.) The other data objects 292, 294, 296 are determined to be user data objects, and are thus provided to the file system user data object manager 280. In a similar manner, the file system user data object manager 280 determined that the second user data file 292 represents an image, and so provides the second user data file 292 to a file system user image data object manager 282, which is capable of applying the “print” task to the represented image. The remaining user data files 294, 296 are determined to comprise text, and so are provided to a file system user text data object manager 284. This data object manager identifies the third user text data file 294 as comprising XML text data, which is accordingly provided to a file system user XML text data object manager 286 capable of applying the “print” task to user XML text data, and identifies the fourth user text data file 296 as comprising non-XML text data, which is accordingly provided to a file system user non-XML text data object manager 288 capable of applying the “print” task to user non-XML text data. In this manner, the plurality of data object managers may be configured and interoperably coupled to apply rules and tasks to variously specialized data object types.

A second aspect of the data object managers that may be embodied in various aspects pertains to the application of rules to non-standard data object types. This aspect may become relevant where a rule is to be applied to an unknown data object, such as an unidentified type of data file stored in a file system. This aspect may also become relevant where a hierarchical data object set map produces a data object of a type that the data object managers are not particularly configured to manage, e.g., a novel type of linking data object. In these scenarios, it may be difficult to apply the rules to the data object in the absence of a data object manager configured to process objects of the non-standard data object type. Several techniques may be implemented to handle such scenarios. In one embodiment, the unidentified data object may simply be omitted from rule processing and data object management, may raise a warning or exception, or may notify or request input from a system administrator. In another embodiment, a data object manager may designated as the default data object manager for all types of data objects, including generic, non-standard, or unidentifiable data objects. For example, a default data object manager may endeavor to apply a “copy” rule to an unknown data object by applying a bitwise or per-field copy constructor. In a third embodiment, a component of the computer system (e.g., the operation coordinator component) may be configured to analyze the unidentified data object and attempt to discern its data object type, such as by applying heuristics (e.g., statistical analysis), or by requesting analysis of the unknown data object type by a reflection API. The component may provide the data object to the appropriate data object manager upon a successful analysis, or may resort to other techniques in the case of a failed data object type analysis.

In a fourth embodiment comprising a variation of this aspect, the computer system may be devised as a “plug-in” architecture, which is configured to accept customized data object managers that are configured to handle non-standard or custom data object types. This architecture may be achieved in systems implementing these techniques, such as the exemplary system 40 of FIG. 3, by including a custom data object manager interface component configured to include with the at least one data manager at least one custom data object manager, which may then participate in the application of the rules to the data object set. For example, in relation to the exemplary data object manager set 270 in FIG. 10, the operation coordinator component 32 may be unable to find a data object manager configured to apply the “print” task to a user data file in the file system comprising an audio file. However, a system administrator may provide (e.g., may plug into the computer system, such as by operable configuration with the operation coordinator component 32) a custom data object manager configured to apply various rules and tasks to audio files. The custom data object manager may therefore be able to apply the “print” task to the user audio data file by printing various metadata fields stored in the audio file (e.g., the recording date, length, and sampling rate of the audio recording.) Those of ordinary skill in the art may be able to devise many such techniques for handling non-standard data object types in accordance with the techniques described herein. The plug-in architecture for including new data object managers may also be advantageous for applying the rules to new types of computer systems. As one example, a rule set may be not applicable through a file system data object manager where the data files are stored in a novel or unknown file system. Such inoperability may be overcome by plugging into the system a custom data object manager capable of accessing files through the novel file system. As another example, a data object manager may be replaced or overridden by a custom data object manager that provides more accurate or sophisticated application of the rules to the data object set. For example, a custom data object manager may deny the application of rules to a particular set of data files in a file store, such as security files (e.g., system password hashfiles) designed as only alterable by a system administrator, and thereby preempting the alteration of such files by the general-purpose file store data object manager that may conflict with the computer system security policy.

The foregoing examples illustrate the application of the data object managers with one or more rules comprising an operation to the data objects of a data object set. However, the processing flow of the application may be implemented in many variations, and the operation coordinator component incorporated in systems embodying these techniques may be configured to apply the data object managers with the rules to the data object set in various manners. Some such variations may present advantages and/or mitigate disadvantages with respect to other variations and conventional techniques.

One such variable aspect is contrastingly illustrated in FIG. 1, in which the data object managers are applied with the rules to the data object set in furtherance of the operation 14, and FIG. 2, in which a hierarchical data object set map is first generated with respect to the data object set 24, and then the data object managers are applied with the rules of the data object set through the hierarchical data object set map 26. Each embodiment may have comparative advantages; e.g., the exemplary method 10 of FIG. 1 may begin processing the data objects immediately, whereas the exemplary method 20 of FIG. 2 involves some preprocessing that may permit a more robust performance of the operation on the data object set.

Another variable aspect of the coordination of the operation performance, the data object set managers, the rules comprising the operation, and the data objects in the data object set relates to processing these elements together in various sequences. As one example, the first data object manager may apply the first rule to each of the data objects in the data object set, and may next apply the second rule to each of the data objects, etc.; and when the first data object manager is complete, the second data object manager may be invoked with the same processing sequence. As a second example, the first rule in the operation may be performed by each data object manager on the data object set, followed by applying the second rule by each data object manager to each data object in the data object set, etc. As a third example, the first data object may be provided to each data object manager for processing through each of the rules, followed by providing the second data object to each data object manager, etc. Those of ordinary skill in the art may devise many other methods of covering the three-dimensional processing space represented by the data objects, the data object managers, and the rules while applying the techniques described herein.

A third variable aspect of the coordination of the operation performance, the data object set managers, the rules comprising the operation, and the data object in the data set relates to the types of data objects provided to each data object manager. As noted, each data object manager is configured to process at least one data object type among the various data objects comprising the data object set. Moreover, if the data object managers expressly indicate the data object types that each can process, the computer system may utilize this information to filter the data objects provided to the data object managers. Accordingly, the computer system (e.g., the operation coordinator component) may provide data objects only to the data object managers that are configured to process such data object types. The system may therefore streamline the processing of data objects by data object managers, which may provide improved performance in the rule processing system.

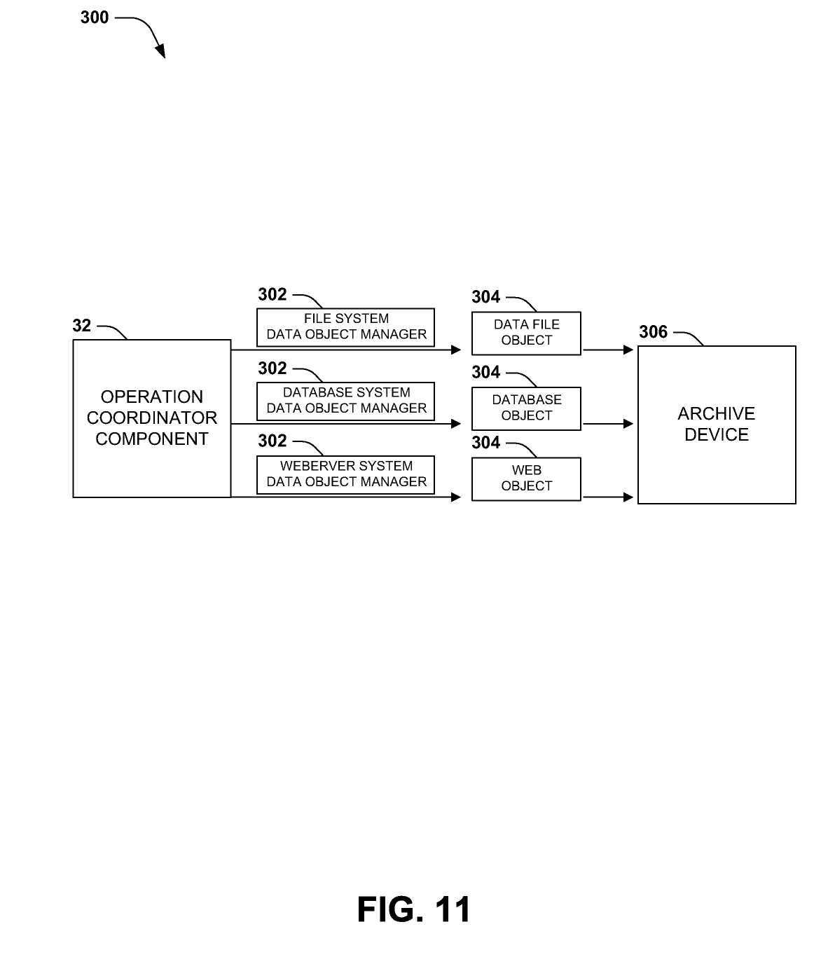

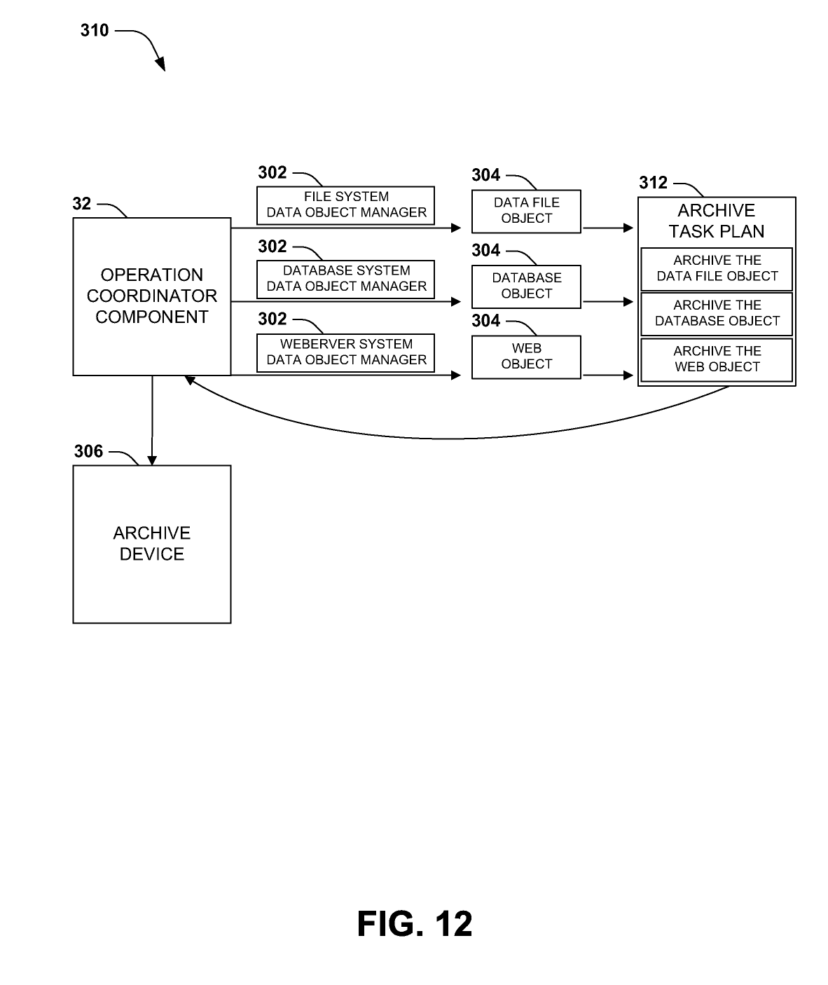

FIGS. 11 and 12 illustrate a fourth variable aspect of the coordination of the operation performance pertaining to the actions carried out by the operating system (e.g., the operation coordinator component) and by the data object set managers. FIG. 11 illustrates an exemplary system 300 in which the operation coordinator component 32 applies the data object managers 302 with a rule to corresponding data objects 304. In this exemplary system 300, the data object managers 302 are configured, upon determining an action for applying a rule to a data object, to proceed with performing the action on the data object. For example, the data object managers 302 may be configured to apply an “archive” task to the data objects 304, and upon identifying a data object 304 that the data object manager 302 is capable of handling, the data object manager 302 sends the data object 304 to the archive device 306. FIG. 12 illustrates a different embodiment, comprising another exemplary system 310 that also comprises an operation coordinator component 32 configured to apply the data object managers 302 with a rule to corresponding data objects 304. However, in this exemplary system 310, the data object managers 302 do not act on the data objects 304, but rather report the appropriate action for applying the rule to particular data objects 304. The reported actions may be compiled into a task plan, such as an archive task plan 312 comprising various actions recommended by the data object managers 302 for archiving the data objects 304. The task plan may be provided to the operation coordination component 32, which may, in one embodiment, perform the recommended options either immediately or during a period of processor idleness. Alternatively, the operation coordination component 32 may present the task plan to a user, such as a system administrator, for review, modification, and/or approval, and may respond to approval of the task plan (in modified or unmodified form) by perform the actions indicated therein. Those of ordinary skill in the art may devise many other methods of applying the rules of the operation to the data objects in accordance with the techniques described herein.

A fifth variable aspect of the coordination of the operation performance relates to operations involving a plurality of data object sets, e.g., a synchronization of one data object set with one or more other data object sets. In one embodiment, such an operation may involve applying the rules to one data object set before applying the rules to the other data object set, e.g., by analyzing the data object sets in series and determining actions for satisfying the rule based on a comparison of the data object set analyses. In another embodiment, some or all of the data object sets may be analyzed in parallel, e.g., by different processors, by different cores in a multicore processor, or by threads of execution in a multithreaded analysis process. Again, actions for satisfying the rule may be determined by comparing the results of the data object set analyses. In a third embodiment, the rule may be applied by directly comparing the plurality of data object sets. For example, a synchronization option may be performed by scanning the data object sets together, e.g., by performing an item-by-item comparison of file system catalogs, and producing one analysis relating the data object sets, which may then be used to determine actions for satisfying the rule. Those of ordinary skill in the art may devise many other methods of arranging the analyses of a plurality of data sets in accordance with the techniques described herein.

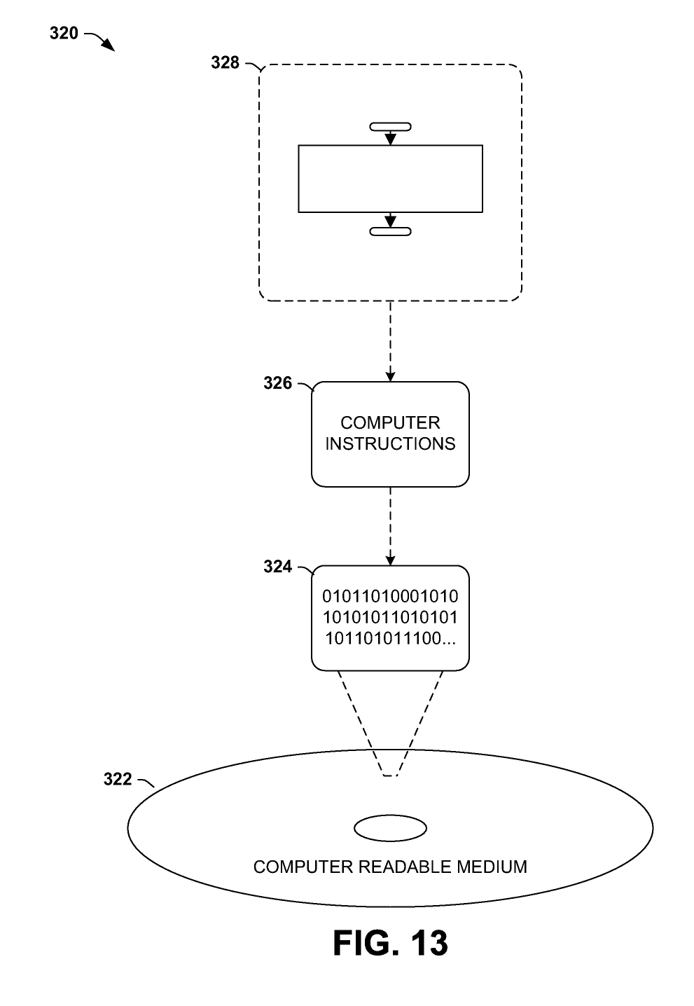

The techniques discussed herein may also be embodied as a computer-readable medium comprising processor-executable instructions configured to generate an aggregated user profile as discussed herein. An exemplary computer-readable medium that may be devised in these ways is illustrated in FIG. 13, wherein the embodiment 320 comprises a computer-readable medium 322 (e.g., a CD-R, DVD-R, or a platter of a hard disk drive), on which is encoded computer-readable data 324. This computer-readable data 324 in turn comprises a set of computer instructions 326 configured to operate according to the principles set forth herein. In one such embodiment, the processor-executable instructions 326 may be configured to perform a method 328 of performing an operation on a data object set, such as the exemplary method illustrated in the flowchart of FIG. 1. In another such embodiment, the processor-executable instructions 326 may be configured to implement a system for performing an operation on a data object set, such as the system illustrated in the component block diagram of FIG. 3. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer-readable media can include but are not limited to magnetic storage devices (e.g., hard disks, floppy disks, and magnetic strips), optical disks (e.g., audio or data compact discs (CDs) and digital versatile discs (DVDs)), smart cards, and flash memory devices (e.g., card, stick, and key drives.) Additionally, it may be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements and/or resources), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of performing an operation on a data object set, the method comprising:
applying to the data object set at least one data object manager configured to apply to at least one data object type in the data object set at least one rule comprising a task to be performed on the data objects of the data object type in furtherance of the operation.

2. The method of claim 1, the operation comprising at least one of an analysis of a data object set, a synchronization of a plurality of data object sets, a data archive operation on a data object set, a data restore operation on a data object set, a server deployment operation on a data object set, a mirroring of a source data object set to at least one destination data object set, and a migration of a data object set to promote compatibility with a new application version.

3. The method of claim 1, the applying comprising applying the rules in series to the data objects.

4. The method of claim 1, the applying comprising applying the rules in parallel to the data objects.

5. The method of claim 1, the applying comprising applying respective rules hierarchically to the data objects that are not handled by previously applied rules.

6. The method of claim 1, comprising:
at least one generic task type configured to perform a generic task on the data objects,
at least one rule specifying at least one generic task type to be performed on the data objects.

7. The method of claim 6, comprising:
at least one generic rule type configured to perform a generic rule on the data objects,
at least one operation specifying at least one generic rule type to be applied to the data objects.

8. The method of claim 1, comprising:
generating a hierarchical data object set map representing the data objects;
where the at least one data object manager applies the at least one rule to the data objects through the hierarchical data object set map.

9. The method of claim 8, the hierarchical data object set map generated from the data object set according to a hierarchical data object set definition.

10. The method of claim 1, the data object set comprising at least one of a derived data object, a data object group, and a linking data object.

11. The method of claim 1, the data object managers comprising at least one custom data object manager.

12. A computer-readable medium comprising processor-executable instructions configured to perform a method of performing an operation on a data object set, the method comprising:
applying to the data object set at least one data object manager configured to apply to at least one data object type in the data object set at least one rule comprising a task to be performed on the data objects of the data object type in furtherance of the operation.

13. A system for performing an operation on a data object set, the system comprising:
at least one rule comprising at least one task to be performed on the data objects of at least one data object type in the data object set in furtherance of the operation;
at least one data object manager configured to apply the at least one rule to the data objects of the at least one data object type; and
an operation coordinator component configured to apply the at least one data object manager with at least one rule to the data object set.

14. The system of claim 13, the operation comprising at least one of an analysis of a data object set, a synchronization of a plurality of data object sets, a data archive operation on a data object set, a data restore operation on a data object set, a server deployment operation on a data object set, a mirroring of a source data object set to at least one destination data object set, and a migration of a data object set to promote compatibility with a new application version.

15. The system of claim 13, comprising:
at least one generic task type configured to perform a generic task on the data objects,
at least one rule specifying at least one generic task type to be applied to the data objects.

16. The system of claim 15, comprising:
at least one generic rule type configured to perform a generic rule on the data objects,
at least one operation specifying at least one generic rule type to be applied to the data objects.

17. The system of claim 13, further comprising:
a hierarchical data object set map generating component configured to generate a hierarchical data object set map from the data object set,
the at least one data object manager configured to apply the at least one rule to the data objects of at least one data object type in the data object set through the hierarchical data object set map.

18. The system of claim 17, the hierarchical data object set map generating component configured to generate the hierarchical data object set map according to a hierarchical data object set definition.

19. The system of claim 13, the data object set comprising at least one of a derived data object, a data object group, and a linking data object.

20. The system of claim 13, comprising:
a custom data object manager interface component configured to include with the at least one data manager at least one custom data object manager.
